(19) United States
(12) Patent Application Publication
(10) Pub. No.: US 2016/0335119 A1
(43) Pub. Date: Nov. 17, 2016

(54) BATCH-BASED NEURAL NETWORK SYSTEM

(71) Applicant: minds.ai inc, Santa Cruz, CA (US)

(72) Inventors: Theodore MERRILL, Santa Cruz, CA (US); Tijmen TIELEMAN, Bilthoven (NL); Sumit SANYAL, Santa Cruz, CA (US); Anil HEBBAR, Bangalore (IN)

(21) Appl. No.: 15/149,990

(22) Filed: May 9, 2016

Related U.S. Application Data
(60) Provisional application No. 62/160,209, filed on May 12, 2015.

(51) Int. Cl. G06F 9/48; G06F 9/50; G06N 3/063

(52) U.S. Cl. CPC G06F 9/4881; G06N 3/063; G06F 9/5083

(57) ABSTRACT

A multi-processor system for batched pattern recognition may utilize a plurality of different types of neural network processors and may perform batched sets of pattern recognition jobs on a two-dimensional array of inner product units (IPUs) by iteratively applying layers of image data to the IPUs in one dimension, while streaming neural weights from an external memory to the IPUs in the other dimension. The system may also include a load scheduler, which may schedule batched jobs from multiple job dispatchers, via initiators, to one or more batched neural network processors for executing the neural network computations.

### CROSS-REFERENCE TO RELATED APPLICATION

This application is a non-provisional application claiming priority to U.S. Provisional Patent Application No. 62/160,209, filed on May 12, 2015, and incorporated by reference herein.

### FIELD

Various aspects of the present disclosure may pertain to various forms of neural network batch processing from custom hardware architectures to multi-processor software implementations, and parallel control of multiple job streams.

### BACKGROUND

Due to recent optimizations, neural networks may be favored as a solution for adaptive learning-based recognition systems. They may currently be used in many applications, including, for example, intelligent web browsers, drug searching, and voice and face recognition.

Fully-connected neural networks may consist of a plurality of nodes, where each node may process the same plurality of input values and produce an output, according to some function of its input values. The functions may be non-linear, and the input values may be either primary inputs or outputs from internal nodes. Many current applications may use partially- or fully-connected neural networks, e.g., as shown in FIG. 1. Fully-connected neural networks may consist of a plurality of input values 10, all of which may be fed into a plurality of input nodes 11, where each input value of each input node may be multiplied by a respective weight 14. A function, such as a normalized sum of these weighted inputs, may outputted from the input nodes 11 and may be fed to all nodes in the next layer of “hidden” nodes 12, all of which may subsequently feed the next layer of “hidden” nodes 16. This process may continue until each node in a layer of “hidden” nodes 16 may feed a plurality of output nodes 13, whose output values 15 may indicate a result of some pattern recognition, for example.

Multi-processor systems or array processor systems, such as Graphic Processing Units (GPUs), may perform the neural network computations on one input pattern at a time. This approach may require large amounts of fast memory to hold the large number of weights necessary to perform the computations. Alternatively, in a “batch” mode, many input patterns may be processed in parallel on the same neural network, thereby allowing the weights to be used across many input patterns. Typically, batch mode may be used when learning, which may require iterative perturbation of the neural network and corresponding iterative application of large sets of input patterns to the perturbed neural network. Skeirik, in U.S. Pat. No. 5,826,249, granted Oct. 20, 1998, describes batching groups of input patterns derived from historical time-stamped data.

Recent systems, such as internet recognition systems, may be applying the same neural network to large numbers of user input patterns. Even in batch mode, this may be a time-consuming process with unacceptable response times. Hence, it may be desirable to have a form of efficient real-time batch mode, not presently available for normal pattern recognition.

### SUMMARY OF VARIOUS ASPECTS OF THE DISCLOSURE

Various aspects of the present disclosure may include hardware-assisted iterative partial processing of multiple pattern recognitions, or jobs, in parallel, where the weights associated with the pattern inputs, which are in common with all the jobs, may be streamed into the parallel processors from external memory.

In one aspect, a batch neural network processor (BNNP) may include a plurality of field-programmable gate arrays (FPGAs) or application-specific integrated circuits (ASICs), each containing a large number of inner product unit (IPU) processing units, image buffers with interconnecting busses and control logic, where a plurality of pattern recognition jobs are loaded, each into one of the plurality of the image buffers, and weights for computing each of the nodes, which may be loaded into the BNNP from external memory. The IPUs may perform, for example, inner product, max pooling, average pooling, and/or local normalization based on opcodes from associated job control logic, and the image buffers may be controlled by data & address control logic.

Other aspects may include a batch-based neural network system comprised of a load scheduler that connects a plurality of job dispatchers and a plurality of initiators, job dispatchers to job initiators each controlling a plurality of associated BNNPs with virtual communication channels to transfer jobs and results between/among them. The BNNPs may be comprised of GPUs, general purpose multi-processors, FPGAs, or ASICs, or combinations thereof. Upon notification to a load scheduler of the completion of a batch of jobs, the job dispatcher may choose to either keep or terminate a communication link, which may be based on the status of other batches of jobs already sent to the BNNP or plurality of BNNPs. Alternatively, upon notification of completion of the batch of jobs, the load scheduler may choose to either keep or terminate the link, based, e.g., on other requests for and the availability of equivalent resources. The job dispatcher may reside in the user's server or in the load scheduler's server. Also, the job dispatcher may choose to request a BNNP for a partial batch of jobs or to send an assigned BNNP a partial batch of jobs over an existing communication link.

Various aspects of the disclosed subject matter may be implemented in hardware, software, firmware, or combinations thereof. Implementations may include a computer-readable medium that may store executable instructions that may result in the execution of various operations that implement various aspects of this disclosure.

### BRIEF DESCRIPTION OF THE DRAWINGS

Embodiments of the invention will now be described in connection with the attached drawings, in which:

FIG. 1 is a diagram of an example of a multi-layer fully-connected neural network,

FIG. 2 is a diagram of an example of a batch neural network processor (BNNP), according to an aspect of this disclosure,

FIG. 3 is a diagram of an example of one inner product unit (IPU) shown in FIG. 2, according to an aspect of this disclosure,

FIG. 4 is a diagram of an example of a multi-bank image buffer shown in FIG. 2, according to an aspect of this disclosure,

FIG. 5 is a diagram of another example of a BNNP, according to an aspect of this disclosure, and

FIG. 6 is a high level diagram of an example of a batch mode neural network system, according to an aspect of this disclosure.

### DETAILED DESCRIPTION OF VARIOUS ASPECTS OF THIS DISCLOSURE

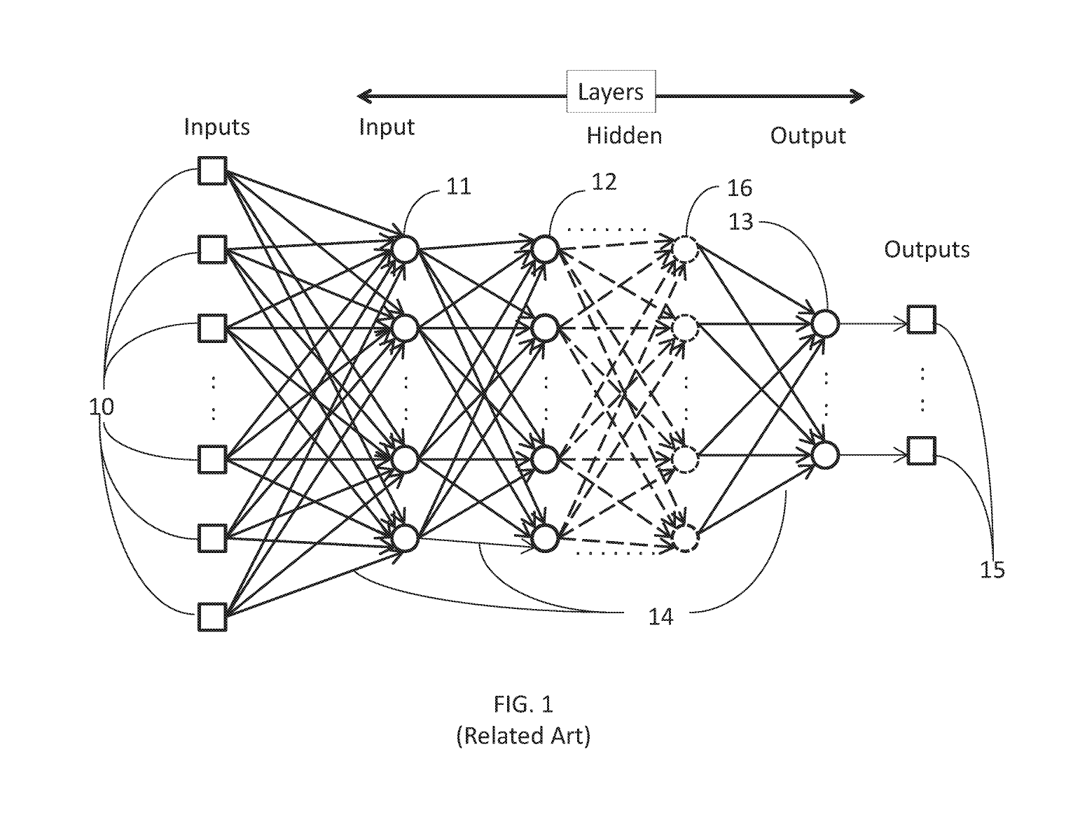

Various aspects of this disclosure are now described with reference to FIGS. 1-6, it being appreciated that the figures illustrate various aspects of the subject matter and may not be to scale or to measure.

### Module

In one aspect of this disclosure, a BNNP may include a plurality of FPGAs and/or ASICs, which may each contain a large number IPUs, image buffers with interconnecting buses, and control logic, where a plurality of pattern recognition jobs may be loaded, each into one of the plurality of the image buffers, and weights for computing each of the nodes may be loaded into the BNNP from external memory.

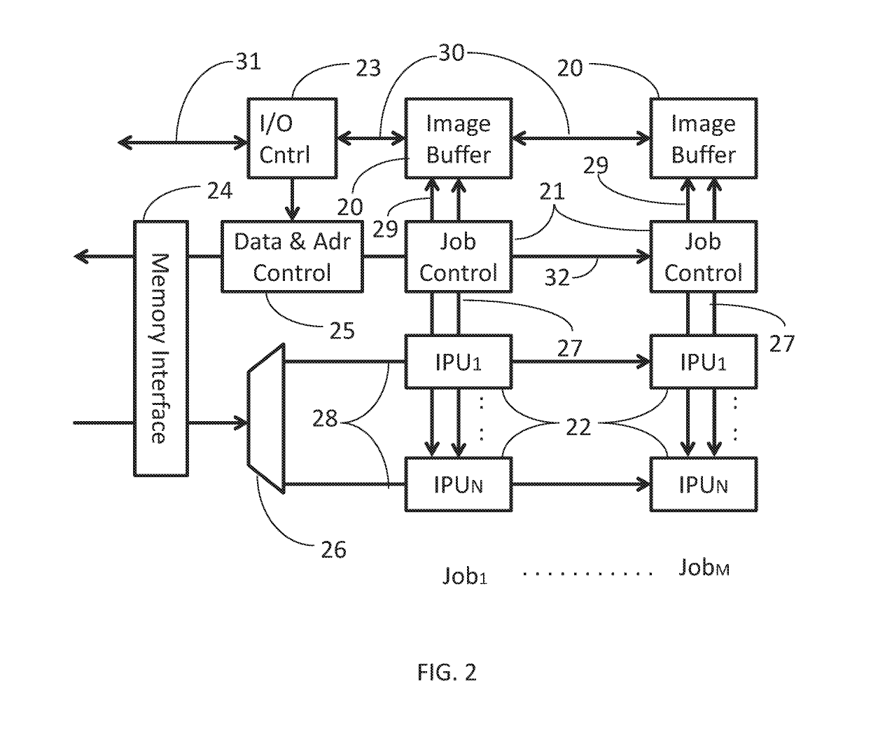

Reference is now made to FIG. 2, a diagram of an example of a BNNP architecture. The BNNP may comprise a plurality of inner product units (IPUs) 22. Each of the IPUs 22 may be driven in parallel by one of a plurality of weight buses 28, which may be loaded from a memory interface 24. Each of the IPUs 22 may also be driven in parallel by one of a plurality of job buses 27, which may be loaded from one of a plurality of image buffers 20. Each of the image buffers 20 may be controlled by job control logic 21, through an image control bus 29, which in turn may be controlled through a job control bus 32 from data & address (D&A) control logic 25. An input/output (I/O) bus 31, may be a PCIe, Firewire, Infiniband or other suitably high-speed bus, connected to suitable I/O control logic 23, which may load commands and weight data into the D&A control logic 25 or may sequentially load or unload each of the image buffers 20 with input data or results through an image bus 30.

To perform a batch of, for example, pattern recognition jobs, which may initially consist of a plurality of input patterns, one pattern per job, that may be inputted to a common neural network with one set of weights for all the jobs in the batch, the patterns may be initially loaded from the I/O bus 31 onto the image bus 30 to be written into the plurality of image buffers 20, one input pattern per image buffer, followed by commands written to the D&A control logic 25 to begin the neural network computations. The D&A control logic 25 may begin the neural network computations by simultaneously issuing burst read commands with addresses through the memory interface 24 to external memory, which may be, for example, double data rate (DDR) memory (not shown), while issuing commands for each job to its respective job control logic 21. There may be M*N IPUs in each FPGA, where each of M jobs may simultaneously use N IPUs to calculate the values of N nodes in each layer (where M and N are positive integers). This may be performed by simultaneously loading M words, one word from each job's image buffer 20, into each job's N IPUs 22, while inputting N words from the external memory, one word for each of the IPUs 22 in all M jobs. This process may continue until all the image buffer data has been loaded into the IPUs 22, after which the IPUs 22 may output their results to each of their respective job buses 27, which may be performed one row of IPUs 22 at a time, for N cycles to be written into the image buffers 20. To compute one layer of the neural network, this process may be repeated until all nodes in the layer have been computed, after which the original inputs may replaced with the results written into the image buffer, and the next layer may be computed until all layers have been computed, after which the neural network results may be returned through the I/O control logic 23 and the I/O bus 31.

Therefore, according to one aspect of the present disclosure, a method for performing batch neural network processing may be as follows:
a) Load each of up to N input banks of respective image buffers with up to M jobs of neural network inputs, one job per image buffer;
b) Simultaneously read M node weights for a given layer of neural network processing from external memory and write each node weight to a respective row of N IPUs, while loading a corresponding job input into M IPUs connected from each image buffer's input bank;
c) In each IPU, multiply the input with the weight and add the product to a result;
d) Repeat b) and c) for all inputs in the image buffer's input bank;
e) For each of M IPUs connected to each image buffer, output the respective IPU's result to the image buffer's output bank, one result at a time;
f) Repeat b), c), d) and e) for all nodes in the layer;
g) Exchange each image buffer's input bank with its output bank, and repeat b), c), d), e), and f) for all layers in the neural network; and
h) Output the results from each image buffer's output bank.

It is noted that the techniques disclosed here may pertain to training, processing of new data, or both.

According to another aspect of the present disclosure, the IPUs may perform inner product, max pooling, average pooling, and/or local normalization based on opcodes from the job control logic.

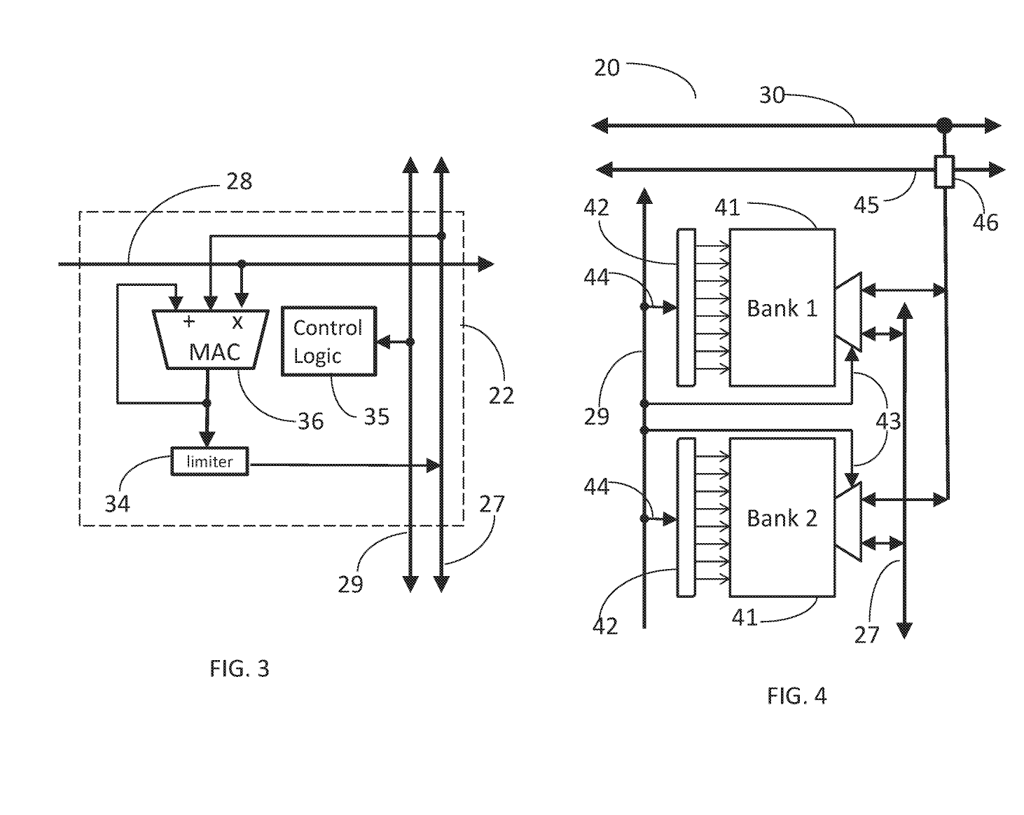

Reference is now made to FIG. 3, a diagram of an example of one inner product unit (IPU) 22, as shown in FIG. 2. The control logic 35 may consist of opcodes loaded from the job control bus 29 and/or counts to perform the opcode operations on the multiplier-accumulator (MAC) 36 and the limiter 34, along with controls to read from and/or write to the job bus 27.

Reference is now made to FIG. 4, a diagram of an example of a multi-bank image buffer 20 and associated job control bus 29, e.g., as shown in FIG. 2. Each bank may have its own control lines 44, from the job control bus 29, including its own bus selection 43, to select between reading or writing to either the job bus 27 or the image bus 30. In one embodiment, each bank's address logic 42 may consist of a settable shift register, which may be initialized to an initial word in the bank and may be incremented to successive words after each read or write. In this manner, each bank may be successively read from and/or written into, independent of the operations or addresses on the other bank. It is further contemplated that there may be more than two banks within each image buffer, or the banks may be different sizes, or the settable shift register may be designed to be set to either any address within the bank or any order of 2 subset of the addresses.

In this manner a first batch of jobs may be loaded into the BNNP, and a second batch jobs may be loaded into a different bank of the image buffers 20 prior to completing the computation on the first batch of jobs, such that the second batch of jobs may begin processing immediately after completing the computation on the first batch of jobs. Furthermore, the results from the first batch of jobs may be returned while the processing continues on the second batch of jobs, if the size of the results and final layer's inputs are less than the size of a bank. By loading the final results into the same bank where the final layer's inputs reside, the other bank may be simultaneously used to load the next batch of jobs. The results may be placed in a location that is an even multiple of N and is larger than the number of inputs, such that the final results do not overlap with the final layer's inputs.

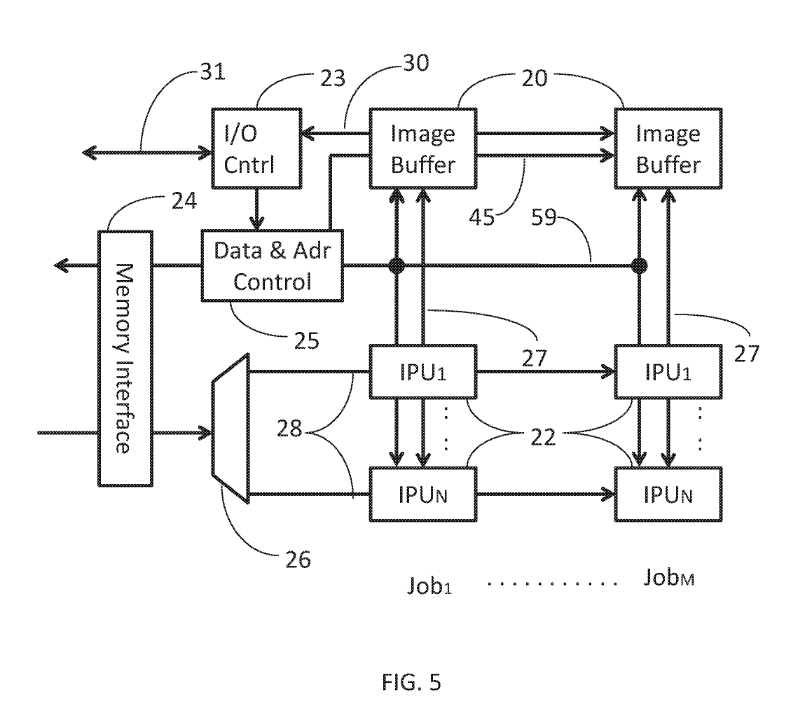

In yet further aspect of this disclosure, the image buffers 20 may be controlled by the D&A control logic 25. Reference is again made to FIG. 4, a diagram of an example of a multi-bank image buffer 20. In this case, an image control bus 45 may select which image buffer 20 connects 46 to the image bus 30. Reference is now made to FIG. 5 another diagram of a batch neural network processor (BNNP), according to a further aspect of this disclosure. In this version, the image buffers 20 may be individually selected by the D&A control logic 25 through the image control bus 45, which may thereby allow all the image buffers 20 to be addressed using the same address on the job control bus 59. The I/O data may be interleaved, such that for M writes to or reads from the I/O control 23, the address and bank on the job control bus 59 may stay the same while on each cycle a different image buffer 20 may be selected via the image control bus 45.

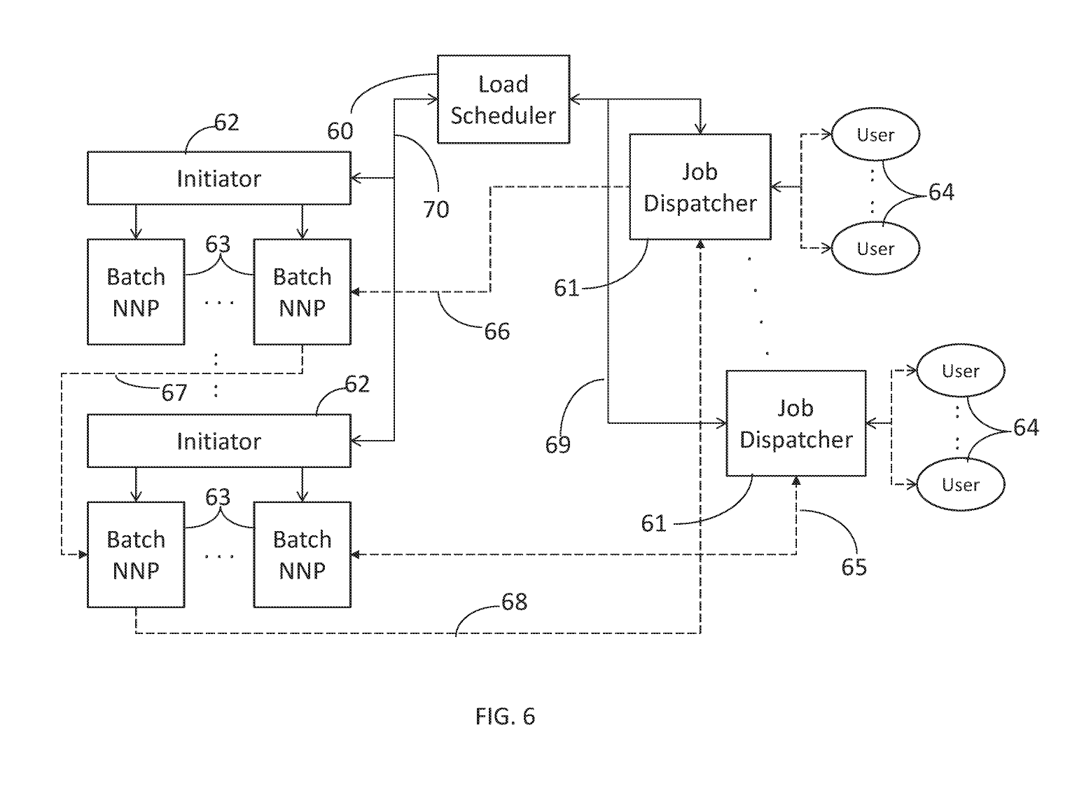

A BNNP need not necessarily reside on a single server; by “reside on,” it is meant that the BNNP may be implemented, e.g., in hardware associated with/controlled by a server or may be implemented in software on a server (as noted above, although hardware implementations are primarily discussed above, analogous functions may be implemented in software stored in a memory medium and run on one or more processors). Rather, it is contemplated that the IPUs 22 of a BNNP may, in some cases (but not necessarily), reside on multiple servers/computing systems, as may various other components shown in FIGS. 2 and 5. In such a case, although the IPUs 22 may be distributed, they may still obtain weights for various training and/or processing jobs. This may be done by means of communication channels among the various servers hosting the IPUs 22 (or other components). Such servers are discussed in connection with FIG. 6, described below. The weights may be compressed to save bandwidth and/or to accommodate low-bandwidth communication channels; however, the invention is not thus limited.

### System

According to a further aspect of this disclosure, a batch-based neural network system may be composed of a load scheduler, a plurality of job dispatchers, and a plurality of initiators, each controlling a plurality of BNNPs, which may be comprised of GPUs, general purpose multi-processors, FPGAs, and/or ASICs. Reference is now made to FIG. 6, a high-level diagram of a of a batch-mode neural network system. A plurality of users 64 may be connected to servers containing a plurality of job dispatchers 61, where a respective job dispatcher 61 may maintain a queue of jobs to be batch-processed, and which may forward the batch requests to a load scheduler 60. The load scheduler 60 may maintain an activity level of each of a plurality of initiators 62 in the system, may request the use of one or more BNNPs 63 from their initiators 62, via a control bus 70, and may set up a communication link 65 between the BNNP 63 and the job dispatcher 61, or a communication chain 66, 67 and 68, between a job dispatcher 61 and a plurality of BNNPs 63. The job dispatcher 61 may then submit one or more batches of jobs to the BNNPs 63, and upon receipt of the results, may notify the load scheduler 60 of the completion of the batch jobs, and may return the results to their respective users 64. The load scheduler 60 may periodically query the plurality of job dispatchers 61 and initiators 62 to determine if they are still operational. Similarly, the initiators 62 may periodically query their BNNPs 63 and may provide to the load scheduler 60 the status of its BNNPs 63, when requested. The load scheduler 60 may keep a continuous transaction log of requests made by the job dispatchers 61, such that if the load scheduler 60 fails to receive a notification of completion of a pending task, the load scheduler 60 may cancel the initial request and may regenerate another request and corresponding communication link between the requesting job dispatcher 61 and the assigned BNNP 63. Though a job dispatcher 61 may have many operational communication links with or among different BNNPs 63, there may be only one communication link between a specific job dispatcher 61 and BNNP 63 pair, which may or may not be terminated upon the completion of the currently requested batch of jobs.

According to another aspect of this disclosure, upon notification to the load scheduler 60 of the completion of a batch of jobs, the job dispatcher 61 may choose to either keep or terminate the communication link, which may be based on the status of other batches of jobs already sent to the BNNP 63 or plurality of BNNPs 63. Alternatively, upon notification of completion of the batch of jobs, the load scheduler 60 may choose to keep or terminate the link, e.g., based on other requests for and the availability of equivalent resources.

It is further contemplated that the job dispatcher 61 may reside either in the user's server or in the load scheduler's 60 server. Also, the job dispatcher 61 may choose to request a BNNP 63 for a partial batch of jobs (less than M jobs) or to send an assigned BNNP 63 a partial batch of jobs over an existing communication link. The decision may be based in part, e.g., on an estimated amount of time to fill the batch of jobs exceeding some threshold that may be derived, e.g., from a rolling average of the requests being submitted by the users 64. It is also contemplated that the threshold may be lower for sending the partial batch of jobs to over an existing communication link, than for requesting a new BNNP 63. Additionally, this may be repeated for multiple partial batches of jobs.

It is further noted that the servers hosting the various system components may also host BNNPs 63 or components thereof (e.g., one or more IPUs 22 and/or other components, as shown in FIGS. 2 and 5); that is, BNNPs 63 or components thereof may reside on these servers. Alternatively, the BNNPs 63 or components thereof may be distributed over other servers (or on a combination of servers hosting the various system components and not hosting system components). As noted above, weights may be communicated to such BNNPs 63 or components thereof via links among such servers (for example, in FIG. 6, various links, e.g., but not limited to, 65, 66, 67, 68 and 70, may be within servers or between servers, or both, and there may also be other communication links not shown).

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. A batch mode neural network system, comprising:
a load scheduler;
one or more job dispatchers coupled to the load scheduler;
a plurality of initiators coupled to the load scheduler; and
a respective plurality of batch neural network processors (NNPs) associated with and coupled to a respective initiator;
wherein the load scheduler is configured to assign a job to an initiator,
wherein a respective initiator is configured to assign the job to at least one of its respective plurality of associated batch NNPs, and
wherein the load scheduler is configured to couple at least one of the one or more job dispatchers with at least one of the plurality of batch NNPs via one or more virtual communication channels to enable transfer of jobs, results, or both jobs and results between them.

2. The system of claim 1, wherein a respective batch NNP is comprised of at least one device selected from the group consisting of: a graphics processing unit (GPU), a general purpose processor, a general purpose multi-processor, a field-programmable gate array (FPGA), and an application-specific integrated circuit (ASIC).

3. The system of claim 1, wherein, upon notification to the load scheduler of completion of a batch of jobs, the job dispatcher is configured to terminate at least one of the one or more virtual communication channels based on status of other batches of jobs sent to batch NNPs.

4. The system of claim 1, wherein, upon notification of completion of a batch of jobs, the load scheduler is configured to terminate at least one of the one or more virtual communication channels based on other job requests and availability of NNPs to handle the other job requests.

5. The system of claim 1, wherein the job dispatcher is configured to send an assigned batch NNP a partial batch of jobs over an existing communication link if the batch NNP is available and if filling the batch will exceed a first threshold of time.

6. The system of claim 5, wherein the job dispatcher is configured to request a batch NNP for a partial batch of jobs if filling the batch will exceed a second threshold of time.

7. The system of claim 6, wherein the first threshold of time is less than the second threshold of time.

8. The system of claim 1, wherein a respective batch NNP comprises: :
a memory interface coupled to at least one memory device external to the batch NNP;
an M row by N column array of processing units, where M and N are integers greater than or equal to two;
N image buffers;
N job control logic units; and
N job buses coupled to respective ones of the N job control logic units;
wherein a respective image buffer is coupled to a respective column of the processing units through a job bus, and
wherein the memory interface is configured to read M words of data from the external memory and to write a respective one of the M words of data to a respective row of N processing units.

9. The system of claim 1, wherein the plurality of batch NNPs resides on at least two servers, and wherein the at least two servers are configured to communicate neural network weight information in compressed form.

10. A batch neural network processor (BNNP) comprising:
a memory interface coupled to at least one memory device external to the BNNP;
an M row by N column array of processing units, where M and N are integers greater than or equal to two;
N image buffers;
N job control logic units; and
N job buses coupled to respective ones of the N job control logic units;
wherein a respective image buffer is coupled to a respective column of the processing units through a job bus, and
wherein the memory interface is configured to read M words of data from the external memory and to write a respective one of the M words of data to a respective row of N processing units.

11. The BNNP of claim 10, wherein a respective column of processing units is configured to receive one or more opcodes from a respective job control logic unit to indicate to the respective column of processing units to perform one of the operations selected from the group consisting of: inner product, max pooling, average pooling, and local normalization.

12. The BNNP of claim 10, wherein a respective image buffer is controlled by a respective job control logic unit.

13. The BNNP of claim 10, wherein a respective processing unit comprises an inner product unit (IPU).

14. The BNNP of claim 13, wherein the IPU comprises:
a multiplier-accumulator (MAC) unit configured to operate on inputs to the IPU; and
a control logic unit configured to control the MAC unit to perform a particular operation on the inputs to the IPU.

15. The BNNP of claim 14, wherein the particular operation is selected from the group consisting of: inner product, max pooling, average pooling, and local normalization.

16. A method of batch neural network processing in a neural network processing (NNP) unit comprising M rows and N columns of processing units, where M and N are integers greater than or equal to two, the method including:
a) loading input banks of up to N image buffers associated with the N columns of processing units with up to M jobs of neural network inputs, one job per image buffer;
b) simultaneously reading M node weights from external memory;
c) writing a respective node weight to a respective row of N processing units, while loading a corresponding job input into M processing units from the input bank of an associated image buffer;
d) in respective processing units, multiplying respective job inputs with respective weights, and adding the product to a result;
e) repeating b, c and d for all job inputs in a respective image buffer's input bank;
f) for a respective one of the M processing units associated with a respective image buffer, outputting the result of the respective processing unit to an output bank of the image buffer;
g) repeating b, c, d, e and f for all nodes in a layer of a neural network;
h) exchanging a respective image buffer's input bank with its output bank, and repeating steps b, c, d, e, f and g for respective layers of the neural network; and
i) outputting results from a respective image buffer's output bank.

17. A method of neural network processing comprising training a neural network using the method of claim 16.

18. A method of batch neural network processing by a neural network processing system, the method including:
receiving, at one or more job dispatchers, one or more neural network processing jobs from one or more job sources;
assigning a respective job of the one or more neural network processing jobs, by a load scheduler, to an initiator coupled to an associated plurality of batch neural network processors (BNNPs);
assigning, by the initiator, the respective job to at least one of its associated plurality of BNNPs; and
coupling, by the load scheduler, at least one of the one or more job dispatchers with at least one BNNP via one or more virtual communication channels to enable transfer of jobs, results, or both jobs and results between the at least one of the one or more job dispatchers and the at least one BNNP.

19. The method of claim 18, further including, upon notification to the load scheduler of completion of a batch of jobs, terminating, by the job dispatcher, at least one of the one or more virtual communication channels based on status of other batches of jobs sent to BNNPs.

20. The method of claim 18, further including, upon notification of completion of a batch of jobs, terminating, by the load scheduler, at least one of the one or more virtual communication channels based on other job requests and availability of BNNPs to handle the other job requests.

21. The method of claim 18, further including sending, by the job dispatcher to an assigned BNNP, a partial batch of jobs over an existing communication link if the BNNP is available and if filling the batch will exceed a first threshold of time.

22. The method of claim 18, further including requesting, by the job dispatcher, a BNNP for a partial batch of jobs if filling the batch will exceed a second threshold of time, wherein the second threshold of time is greater than the first threshold of time.

23. A memory medium containing software configured to run on at least one processor and to cause the at least one processor to implement operations corresponding to the method of claim 16.

24. A memory medium containing software configured to run on at least one processor and to cause the at least one processor to implement operations corresponding to the method of claim 18.
